(19) United States
(12) Patent Application Publication
(10) Pub. No.: US 2008/0086897 A1
(43) Pub. Date: Apr. 17, 2008

(54) Comb fixed scissors

(76) Inventor: Steve Sanghoo Kim, Des Plaines, IL (US)

Correspondence Address: Steve S. Kim;APT# 201, 1480 Jefferson ST, Des Plaines, IL, 60016, US

(21) Appl. No.: 11/497,771

(22) Filed: Oct. 16, 2006

(51) Int. Cl. B26B 13/00

(52) U.S. Cl. 30/233.5

(57) ABSTRACT

I invented COMB CUT SCISSORS which having a cut comb on the one part of scissors for two functions of hairs lining up and cutting. A comb can be cut at half width of any one part of scissors. Hairs may line up at each comb slot and cut at bottom of the comb. People can hair cut their friends or by themselves with one hand.

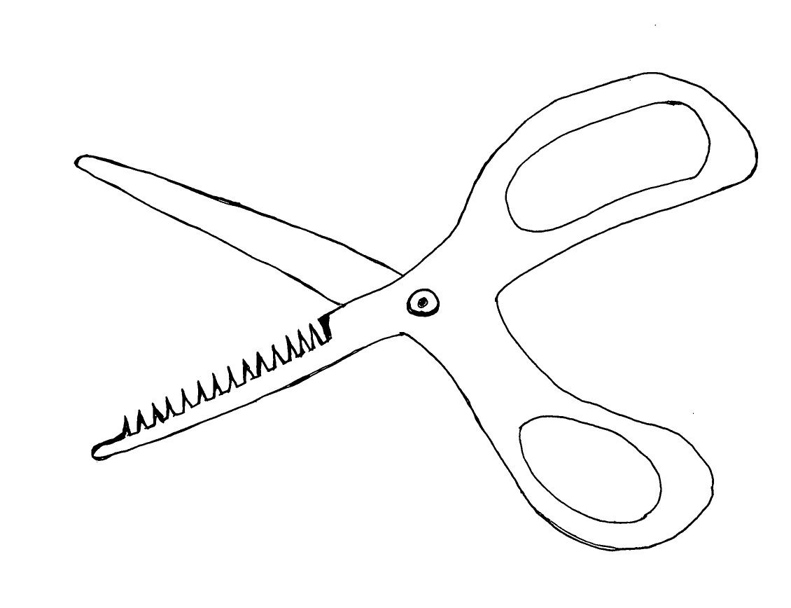

### CROSS-REFERENCE TO RELATED APPLICATION

NOT APPLICABLE

### STATEMENT REGARDING FEDERALLY SPONSORED RESEARCH

NOT APPLICABLE

### REFERENCE SEQUENCE LISTING, A TABLE, OR A COMPUTER

NOT APPLICABLE

### BACKGROUND TO INVENTION

I tried to invent easy hair cutting method to hair cut by myself. So I found scissors having a comb on that by cutting.

### BRIEF SUMMARY OF THE INVENTION

When hair cut, people use two hands for comb and scissors. I invented scissors which a comb is cut on one part of the scissors. So, these scissors do two functions of comb and cut for hair cutting.

### BRIEF DESCRIPTION OF THE SEVERAL VIEWS OF THE DRAWING

Choose any one part of scissors and cut a comb on it about half width of the scissor, then hairs may line up at each of the comb slots and be cut by scissors at bottom of comb.

### DETAILED DESCRIPTION OF THE INVENTION

It's a simple idea to cut a comb on the one part of scissors for two functions of comb and cut for hairs cutting.

I claim:

1. Scissors which having a cut comb on the one part of scissors for two functions of comb and cutting hairs.
